(19) United States
(12) Patent Application Publication
(10) Pub. No.: US 2024/0212636 A1
(43) Pub. Date: Jun. 27, 2024

(54) BRIGHTNESS REGULATING METHOD, BRIGHTNESS REGULATING SYSTEM AND DISPLAY DEVICE

(71) Applicants: Hefei BOE Optoelectronics Technology Co., Ltd., Hefei, Anhui (CN); BOE Technology Group Co., Ltd., Beijing (CN)

(72) Inventors: Chengwei LI, Beijing (CN); Dayu ZHANG, Beijing (CN); Zhiwei ZHANG, Beijing (CN); Xinchen MA, Beijing (CN)

(21) Appl. No.: 17/919,856

(22) PCT Filed: Oct. 27, 2021
(86) PCT No.: PCT/CN2021/126830

§ 371 Date: Oct. 19, 2022

(51) Int. Cl. G09G 3/34; G09G 3/20

(52) U.S. Cl. CPC G09G 3/342; G09G 3/2007; G09G 2320/0233; G09G 2320/0686; G09G 2360/16

(57) ABSTRACT

The present application provides a brightness regulating method, a brightness regulating system and a display device, which relates to the technical field of displaying. The brightness regulating method includes: dividing the backlight module into a plurality of light areas; according to brightnesses of the light areas, determining a reference light area; according to a brightness of the reference light area, determining a compensation parameter of a to-be-compensated light area; converting the compensation parameter into compensated-grayscale data of the display panel; and according to the compensated-grayscale data, controlling a display frame corresponding to the to-be-compensated light area to display a brightness that has been updated.

### TECHNICAL FIELD

The present application relates to the technical field of displaying and, more particularly, to a brightness regulating method, a brightness regulating system and a display device.

### BACKGROUND

With the rapid development of the technique of displaying, Mini Light Emitting Diode (Mini LED) and Micro Light Emitting Diode (Micro LED) display products have attracted broad attention. However, the display frames of the Mini LED and Micro LED display products have the problem of ununiform brightness, which deteriorates the effect of displaying.

### SUMMARY

The embodiments of the present application employ the following technical solutions:

In an aspect, an embodiment of the present application provides a brightness regulating method, wherein the brightness regulating method is applied to a display module, the display module comprises a backlight module and a display panel, the display panel is located on a light exiting side of the backlight module, and the brightness regulating method comprises:
dividing the backlight module into a plurality of light areas;
according to brightnesses of the light areas, determining a reference light area;
according to a brightness of the reference light area, determining a compensation parameter of a to-be-compensated light area;
converting the compensation parameter into compensated-grayscale data of the display panel; and
according to the compensated-grayscale data, controlling a display frame corresponding to the to-be-compensated light area to display a brightness that has been updated.

In some embodiments of the present application, the step of, according to the brightnesses of the light areas, determining the reference light area comprises:
in one frame of the display frame, determining the brightnesses of the light areas; and
selecting a light area having a maximum brightness to be the reference light area.

In some embodiments of the present application, the step of, according to the brightness of the reference light area, determining the compensation parameter of the to-be-compensated light area comprises:
in one frame of the display frame, determining the brightness of the reference light area;
determining a brightness of the to-be-compensated light area; and
according to the brightness of the reference light area and the brightness of the to-be-compensated light area in a same one frame of the display frame, determining the compensation parameter of the to-be-compensated light area.

In some embodiments of the present application, the step of, according to the brightness of the reference light area and the brightness of the to-be-compensated light area in the same one frame of the display frame, determining the compensation parameter of the to-be-compensated light area comprises:
regarding a ratio of the brightness of the reference light area to the brightness of the to-be-compensated light area in the same one frame of the display frame as the compensation parameter of the to-be-compensated light area.

In some embodiments of the present application, the step of, according to the compensated-grayscale data, controlling the display frame corresponding to the to-be-compensated light area to display the brightness that has been updated comprises:
according to the compensated-grayscale data, updating a transmittance of a display panel corresponding to the to-be-compensated light area, wherein the brightness that has been updated of the display frame corresponding to the to-be-compensated light area is equal to a product obtained by multiplying the brightness of the to-be-compensated light area by a transmittance that has been updated.

In some embodiments of the present application, the step of, in the one frame of the display frame, determining the brightnesses of the light areas comprises:
in the one frame of the display frame, determining maximum grayscales of display frames corresponding to the light areas; and
according to the maximum grayscales of the display frames corresponding to the light areas, determining the brightnesses of the light areas.

In some embodiments of the present application, the to-be-compensated light area includes at least one of the other light areas than the reference light area.

In another aspect, an embodiment of the present application provides a brightness regulating system, wherein the brightness regulating system comprises: a controller and a display module, the display module comprises a backlight module and a display panel, and the backlight module and the display panel are electrically connected to the controller:
the controller comprises an area dividing and light regulating unit and a controlling unit;
the area dividing and light regulating unit is electrically connected to the controlling unit and the backlight module;
the area dividing and light regulating unit is configured for dividing the backlight module into a plurality of light areas; according to brightnesses of the light areas, determining a reference light area; and according to a brightness of the reference light area, determining a compensation parameter of a to-be-compensated light area; and
the controlling unit is configured for acquiring the compensation parameter, and converting the compensation parameter into compensated-grayscale data of the display panel; and according to the compensated-grayscale data, controlling a display frame corresponding to the to-be-compensated light area to display a brightness that has been updated.

In some embodiments of the present application, the area dividing and light regulating unit comprises an area dividing subunit and a light regulating subunit;
the area dividing subunit is configured for dividing the backlight module into the plurality of light areas; and
the light regulating subunit is configured for, according to brightnesses of the light areas, determining the reference light area; and according to a brightness of the reference light area, determining the compensation parameter of the to-be-compensated light area.

In some embodiments of the present application, the light regulating subunit comprises a first data acquiring module and a compensation calculating module;
the first data acquiring module is configured for, in one frame of the display frame, acquiring the brightnesses of the light areas; acquiring the brightness of the reference light area; and acquiring the brightness of the to-be-compensated light area; and
the compensation calculating module is configured for selecting a light area having a maximum brightness to be the reference light area; and according to the brightness of the reference light area and the brightness of the to-be-compensated light area in a same one frame of the display frame, determining the compensation parameter of the to-be-compensated light area, wherein the compensation parameter refers to a ratio of the brightness of the reference light area to the brightness of the to-be-compensated light area in the same one frame of the display frame.

In some embodiments of the present application, the controlling unit comprises a second data acquiring module and a compensation correcting module;
the second data acquiring module is configured for acquiring the compensation parameter of the to-be-compensated light area; and
the compensation correcting module is configured for converting the compensation parameter into compensated-grayscale data of the display panel; and according to the compensated-grayscale data, controlling to update a transmittance of a display panel corresponding to the to-be-compensated light area, wherein the brightness that has been updated of the display frame corresponding to the to-be-compensated light area is equal to a product obtained by multiplying the brightness of the to-be-compensated light area by a transmittance that has been updated.

In some embodiments of the present application, the brightnesses of the light areas are determined according to the maximum grayscales of the display frames corresponding to the light areas.

In some embodiments of the present application, the to-be-compensated light area includes at least one of the other light areas than the reference light area.

In yet another aspect, an embodiment of the present application further provides a display device, wherein the display device comprises the brightness regulating system stated above.

The above description is merely a summary of the technical solutions of the present application. In order to more clearly know the elements of the present application to enable the implementation according to the contents of the description, and in order to make the above and other purposes, features and advantages of the present application more apparent and understandable, the particular embodiments of the present application are provided below.

### BRIEF DESCRIPTION OF THE DRAWINGS

In order to more clearly illustrate the technical solutions of the embodiments of the present application or the related art, the figures that are required to describe the embodiments or the related art will be briefly introduced below. Apparently, the figures that are described below are merely embodiments of the present application, and a person skilled in the art may obtain other figures according to these figures without paying creative work.

FIGS. 1a and 1b are grayscale-transmittance curve diagrams of the display module corresponding to different light areas according to an embodiment of the present application:

FIG. 2 is a flow chart of a brightness regulating method according to an embodiment of the present application:

FIG. 3 is a schematic diagram of the arrangement of the light areas of a backlight module according to an embodiment of the present application:

FIG. 4a is a schematic structural diagram of a brightness regulating system according to an embodiment of the present application; and

FIG. 4b is a schematic structural diagram of another brightness regulating system according to an embodiment of the present application.

### DETAILED DESCRIPTION

The technical solutions of the embodiments of the present application will be clearly and completely described below with reference to the drawings of the embodiments of the present application. Apparently, the described embodiments are merely certain embodiments of the present application, rather than all of the embodiments. All of the other embodiments that a person skilled in the art obtains on the basis of the embodiments of the present application without paying creative work fall within the protection scope of the present application.

In the drawings, in order for clarity, the thicknesses of the areas and the layers might be exaggerated. In the drawings, the same reference numbers represent the same or similar components, and therefore the detailed description on them are omitted. Moreover, the drawings are merely schematic illustrations of the present disclosure, and are not necessarily drawn to scale.

In the embodiments of the present application, unless stated otherwise, the meaning of “plurality of” is “two or more”. The terms that indicate orientation or position relations, such as “upper”, are based on the orientation or position relations shown in the drawings, and are merely for conveniently describing the present application and simplifying the description, rather than indicating or implying that the component or element must have the specific orientation and be constructed and operated according to the specific orientation. Therefore, they should not be construed as a limitation on the present application.

Unless stated otherwise in the context, throughout the description and the claims, the term “comprise” is interpreted as the meaning of opened containing, i.e., “including but not limited to”. In the description of the present disclosure, the terms “one embodiment”, “some embodiments”, “exemplary embodiments”, “example”, “specific example” or “some examples” are intended to indicate that specific features, structures, materials or characteristics related to the embodiment or example are comprised in at least one embodiment or example of the present application. The illustrative indication of the above terms does not necessarily refer to the same one embodiment or example. Moreover, the specific features, structures, materials or characteristics may be comprised in any one or more embodiments or examples in any suitable manner.

In the embodiments of the present application, terms such as “first” and “second” are used to distinguish identical items or similar items that have substantially the same functions and effects, merely in order to clearly describe the technical solutions of the embodiments of the present application, and should not be construed as indicating or implying the degrees of importance or implicitly indicating the quantity of the specified technical features.

With the rapid development of the technique of displaying, people are having increasingly higher requirements on the image quality of display products. The grade of the image quality is influenced by the light source provided by the backlight module. Regarding Mini LED backlight modules in the related art, area-divided control may be performed to the backlight modules by using a local light regulating function: for example, one of the light areas may be controlled separately to be in a lightening state or an extinguishing state. In practical applications, when the backlight modules are applied to display products, because the maximum brightnesses of the light areas of the backlight module are different, as a result, the display frames of the display products also have the problem of ununiform brightness.

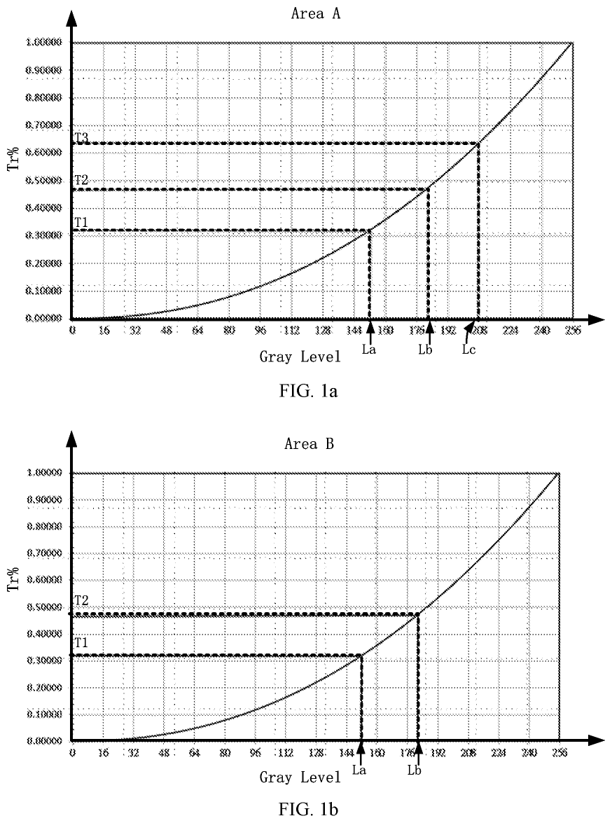

In the related art, a display module comprises a backlight module and a display panel located on the light exiting side of the backlight module, and the maximum brightnesses of the different divided areas in the backlight module are different. In practical applications, if the brightness of the divided area A (Area A) in the backlight module is Y1, the brightness of the divided area B (Area B) is Y2, and Y1≠Y2, referring to FIGS. 1a and 1b, with the equal grayscale, the transmittance of the area of the display module that corresponds to the divided area A and the transmittance of the area of the display module that corresponds to the divided area B are equal. As an example, with the grayscale of La, both of the transmittance of the area of the display module that corresponds to the divided area A and the transmittance of the area of the display module that corresponds to the divided area B are T1, and with the grayscale of Lb, both of the transmittance of the area of the display module that corresponds to the divided area A and the transmittance of the area of the display module that corresponds to the divided area B are T2. Because the brightness of a local area of the display module is =the brightness of the divided area of the backlight module×the transmittance of the area of the display module that corresponds to the divided area, and with the same grayscale, the brightnesses of different divided areas are unequal, when the display module is displaying pure-color frames, the problem of ununiform brightness of the display frames is very significant, which seriously deteriorates the effect of displaying.

In view of that, an embodiment of the present application provides a brightness regulating method, wherein the brightness regulating method is applied to a display module, the display module comprises a backlight module and a display panel, and the display panel is located on a light exiting side of the backlight module. It should be noted that the brightness compensating method according to the present application may compensate any frames of the display module, and is not limited to pure-color frames.

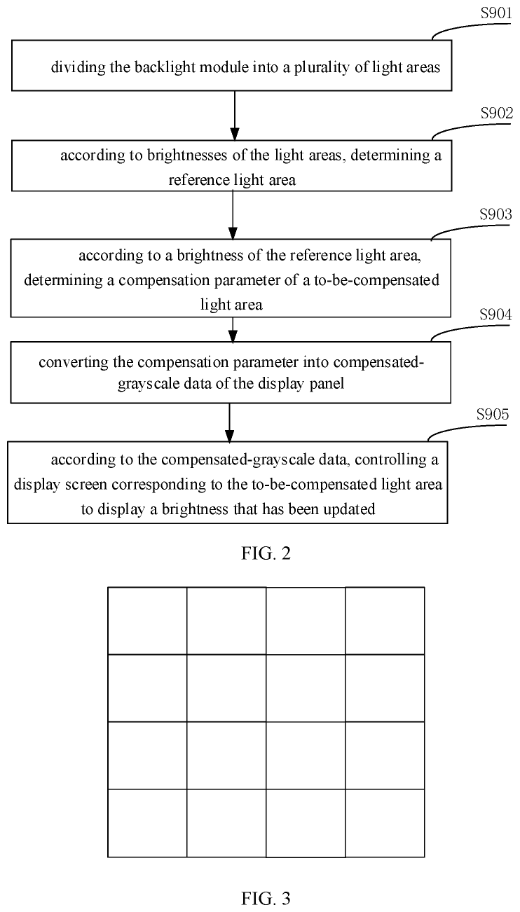

Particularly, referring to FIG. 2, the brightness regulating method comprises:

S901: dividing the backlight module into a plurality of light areas.

As an example, the backlight module may be divided into 9 light areas, 16 light areas or 25 light areas, or even be divided into 3000-5000 light areas. The state of each of the light areas obtained after the area division may be separately controlled, for example, one light area is separately controlled to be in a lightening state or an extinguishing state. The brightnesses of one light area may also be separately controlled, for example, one light area is separately controlled to increase or reduce its brightness.

FIG. 3 shows a schematic diagram of dividing the backlight source of the backlight module into 16 light areas, wherein each of the blocks in FIG. 3 represents one light area.

In an exemplary embodiment, the backlight module may be a Mini LED (Mini Light Emitting Diode) backlight module, and may also be a Micro LED (Micro Light Emitting Diode) backlight module.

FIG. 3 shows a schematic diagram of dividing the backlight source of the backlight module into 16 light areas, wherein each of the blocks in FIG. 3 represents one light area.

S902: according to brightnesses of the light areas, determining a reference light area.

In practical applications, in the same one frame of the display frame, the brightnesses of the light areas are determined, and a light area that has the maximum brightness in the one frame of the display frame is selected to be the reference light area.

In an exemplary embodiment, in the same one frame of the display frame, the brightnesses of the light areas may be equal. Alternatively, the brightnesses of the light areas may be unequal. Alternatively, some of the brightnesses of the light areas may be equal, and some of the brightnesses of the light areas may be unequal.

In an exemplary embodiment, in the same one frame of the display frame, the brightnesses of the light areas are related to the maximum grayscale values of the display frames corresponding to the light areas. For example, the maximum grayscale of the display frame corresponding to a light area 1 is L200, and the brightness of the light area 1 may be controlled by using an area-divided control function of the backlight module to satisfy the brightness of a display frame whose grayscale is L200. The maximum grayscale of the display frame corresponding to a light area 2 is L250, and the brightness of the light area 2 may be controlled by using the area-divided control function of the backlight module to satisfy the brightness of a display frame whose grayscale is L250. The brightness of the light area 1 and the brightness of the light area 2 are unequal, which, as compared with the case in which the brightnesses of all of the light areas are controlled to be equal, may significantly reduce the power consumption of the backlight module, and reduce the cost.

It should be noted that the maximum grayscale value of the display frame refers to the maximum grayscale of the displaying pixels corresponding to the display frame.

S903: according to a brightness of the reference light area, determining a compensation parameter of a to-be-compensated light area.

In an exemplary embodiment, the step of determining the compensation parameter comprises: in one frame of the display frame, determining the brightness of the reference light area; determining a brightness of the to-be-compensated light area; and according to the brightness of the reference light area and the brightness of the to-be-compensated light area in the same one frame of the display frame, determining a compensation parameter of a to-be-compensated light area.

The compensation parameter of the to-be-compensated light area refers to a ratio of the brightness of the reference light area to the brightness of the to-be-compensated light area in the same one frame of the display frame. Each to-be-compensated light area corresponds to one compensation parameter.

In an exemplary embodiment, the brightness of the reference light area and the brightness of the to-be-compensated light area in one frame of the display frame may be determined at a same time. Alternatively, the brightness of the reference light area may be firstly determined, and the brightness of the to-be-compensated light area may be subsequently determined. Alternatively, the brightness of the to-be-compensated light area may be firstly determined, and the brightness of the reference light area may be subsequently determined.

In an exemplary embodiment, the to-be-compensated light area includes at least one light area other than the reference light area.

In an exemplary embodiment, when the to-be-compensated light area is a plurality of to-be-compensated light areas, the brightnesses of the to-be-compensated light areas may be determined at a same time. Alternatively, the brightnesses of the to-be-compensated light areas may be sequentially determined.

S904: converting the compensation parameter into compensated-grayscale data of the display panel.

In an exemplary embodiment, regarding one to-be-compensated light area, in the conversion of the compensation parameter into the compensated-grayscale data of the display panel, according to the brightness demand and the compensation parameter of the display frame corresponding to the to-be-compensated light area, the compensation parameter of the to-be-compensated light area is converted into the compensated-grayscale data of the pixels of the display panel corresponding to the to-be-compensated light area, wherein the quantity of the compensated-grayscale data is equal to the quantity of the pixels within the area of the display panel corresponding to the to-be-compensated light area; in other words, one pixel corresponds to one of the compensated-grayscale data.

In practical applications, the compensation parameter of the to-be-compensated light area is calculated by using a backlight-area regulator (Local Dimming Controlling) in the display module. A time schedule controller (TCON) in the display module acquires the compensation parameter of the to-be-compensated light area, converts the compensation parameter into the pixel-grayscale values in the display panel corresponding to the to-be-compensated light area, and subsequently converts into the pixel voltages within the pixel area of the display panel corresponding to the to-be-compensated light area. Both of the pixel-grayscale values and the pixel voltages that are obtained by the conversion of the compensation parameter may serve as the compensated-grayscale data.

S905: according to the compensated-grayscale data, controlling a display frame corresponding to the to-be-compensated light area to display a brightness that has been updated.

In practical applications, by using the compensated-grayscale data, the transmittance of the display panel corresponding to the to-be-compensated light area is controlled to update, to realize the compensation on the backlights of the different light areas.

In an exemplary embodiment, this step may comprise, according to the compensated-grayscale data updating a transmittance of a display panel corresponding to the to-be-compensated light area, wherein the brightness that has been updated of the display frame corresponding to the to-be-compensated light area is equal to a product obtained by multiplying the brightness of the to-be-compensated light area by a transmittance that has been updated.

In an exemplary embodiment, the compensated-grayscale data may include the pixel-grayscale values and the pixel voltages of the pixels of a local area of the display panel corresponding to the to-be-compensated light area. Particularly, the time schedule controller (TCON) transmits a compensated-grayscale value to a driving chip of the display panel (for example, a source driving chip, which is also referred to as Source Driver), the driving chip is electrically connected to the data-signal lines in the display panel that are arranged in an array, and the driving chip converts the compensated-grayscale value into the pixel-voltage value, and transmits the pixel-voltage value to the pixel units via the data-signal lines.

The embodiments of the present application provide a brightness regulating method, wherein the brightness regulating method is applied to a display module, the display module comprises a backlight module and a display panel, the display panel is located on a light exiting side of the backlight module, and the brightness regulating method comprises: dividing the backlight module into a plurality of light areas; according to brightnesses of the light areas, determining a reference light area; according to a brightness of the reference light area, determining a compensation parameter of a to-be-compensated light area; converting the compensation parameter into compensated-grayscale data of the display panel; and according to the compensated-grayscale data, controlling a display frame corresponding to the to-be-compensated light area to display a brightness that has been updated.

In the embodiments of the present application, the light area that has the maximum brightness in the same one frame of the display frame is used as the reference light area, and, by using the brightness of the reference light area as the reference, the compensated-grayscale data in the display panel corresponding to the to-be-compensated light area are regulated, to realize the purpose of compensating the backlights of the different light areas by using the compensated-grayscale data of the display panel, thereby ameliorating the problem of the ununiform brightness of the display frame of the display module, and improving the effect of displaying.

In some embodiments of the present application, the step S902 of, according to the brightnesses of the light areas, determining the reference light area comprises:

S9021: in one frame of the display frame, determining the brightnesses of the light areas.

In an exemplary embodiment, the step S9021 of, in the one frame of the display frame, determining the brightnesses of the light areas comprises:

Sub-step 1: in the one frame of the display frame, determining maximum grayscales of display frames corresponding to the light areas.

Sub-step 2: according to the maximum grayscales of the display frames corresponding to the light areas, determining the brightnesses of the light areas.

In practical applications, the backlight-area regulator may be used to determine the brightness of each of the light areas.

In an exemplary embodiment, in the same one frame of the display frame, the brightnesses of the light areas may be equal. Alternatively, the brightnesses of the light areas may also be unequal.

As an example, in the first frame of the display frame, the brightnesses of the light area 1 and the light area 2 are equal, and in the second frame of the display frame, the brightnesses of the light area 1 and the light area 2 are unequal.

S9022: selecting a light area having a maximum brightness to be the reference light area.

As an example, the maximum grayscale of the pixels of the display panel corresponding to the light area 1 is L200, and the light area 1 is capable of providing the frame brightness corresponding to the displaying grayscale L200 of the display panel. The maximum grayscale of the pixels of the display panel corresponding to the light area 2 is L250, and the light area 2 is capable of providing the frame brightness corresponding to the displaying grayscale L250 of the display panel. The brightnesses of the light area 1 and the light area 2 are unequal, and the brightness of the light area 2 is greater than the brightness of the light area 1.

In the embodiments of the present application, according to the maximum grayscales of the display frames corresponding to the light areas, the brightnesses of the light areas are determined, which, as compared with the mode in the related art in which the brightnesses of the lightened light areas are set to be equal and the brightnesses of the lightened light areas are the brightnesses corresponding to the required maximum grayscales of the pixels in the display panel, may significantly reduce the power consumption of the backlight module, and reduce the cost.

In some embodiments of the present application, the step S903 of, according to the brightness of the reference light area, determining the compensation parameter of the to-be-compensated light area comprises:

S9031: in one frame of the display frame, determining the brightness of the reference light area.

In the one frame of the display frame, the light area that has the maximum brightness among the light areas is used as the reference light area, and the brightness of the light area is determined.

S9032: determining a brightness of the to-be-compensated light area.

S9033: according to the brightness of the reference light area and the brightness of the to-be-compensated light area in the same one frame of the display frame, determining a compensation parameter of a to-be-compensated light area.

In an exemplary embodiment, when one to-be-compensated light area is being compensated, the ratio of the brightness of the reference light area to the brightness of the to-be-compensated light area in the same one frame of the display frame is used as the compensation parameter of the to-be-compensated light area. Each to-be-compensated light area corresponds to one compensation parameter. For example, in the same one frame of the frame, a light area a is the reference light area and has a brightness of Yref, and a light area b is the to-be-compensated light area and has a brightness of Yb. Accordingly, the compensation parameter of the light area b is Yref/Yb.

In practical applications, regarding one to-be-compensated light area, in the conversion of the compensation parameter into the compensated-grayscale data of the display panel, according to the brightness demand and the compensation parameter of the display frame corresponding to the to-be-compensated light area, the compensation parameter of the to-be-compensated light area is converted into the compensated-grayscale data of the pixels of the display panel corresponding to the to-be-compensated light area, wherein the quantity of the compensated-grayscale data is equal to the quantity of the pixels within the area of the display panel corresponding to the to-be-compensated light area; in other words, one pixel corresponds to one of the compensated-grayscale data.

In some embodiments of the present application, the step S905 of, according to the compensated-grayscale data, controlling the display frame corresponding to the to-be-compensated light area to display the brightness that has been updated comprises:

S9051: according to the compensated-grayscale data, updating a transmittance of a display panel corresponding to the to-be-compensated light area, wherein the brightness that has been updated of the display frame corresponding to the to-be-compensated light area is equal to a product obtained by multiplying the brightness of the to-be-compensated light area by a transmittance that has been updated.

In an exemplary embodiment, the compensated-grayscale data may include the pixel-grayscale values and the pixel voltages of the pixels of a local area of the display panel corresponding to the to-be-compensated light area. Particularly, the time schedule controller (TCON) transmits a compensated-grayscale value to a driving chip of the display panel (for example, a source driving chip, which is also referred to as Source Driver), the driving chip is electrically connected to the data-signal lines in the display panel that are arranged in an array, the driving chip converts the compensated-grayscale value into the pixel-voltage value, and transmits the pixel-voltage value to the pixel units via the data-signal lines, and the pixel units adjust the transmittances thereof according to the pixel-voltage value, thereby regulating the brightness of the display panel corresponding to the to-be-compensated light area.

As an example, regarding a certain pixel in the display panel corresponding to the to-be-compensated light area, its to-be-displayed grayscale is L200, the brightness of the light area where it is located is Y2, the brightness of the reference light area is Yref, and the compensation parameter is =Yref/Y2. Before the compensation, the brightness of the pixel is =T1×Y2. After the compensation, its brightness that has been updated is =T2×Y2, wherein T1 is the transmittance before the updating, t2 is the transmittance that has been updated, t2=T1×X, and X may be determined according to the compensation parameter Yref/Y2. It should be noted that, in practical applications, the transmittances of the pixels may be regulated by using the pixel voltages of the pixels.

In the embodiments of the present application, the light area that has the maximum brightness in the same one frame of the display frame is used as the reference light area; by using the brightness of the reference light area as the reference, the compensation parameter is determined according to the brightness of the reference light area and the brightness of the to-be-compensated light area; subsequently, the compensation parameter of the to-be-compensated light area is converted into the compensated-grayscale data of the display panel; and according to the compensated-grayscale data, the transmittance of the display panel is adjusted, to realize the purpose of compensating the backlight brightnesses of the different light areas by using the compensated-grayscale data of the display panel, thereby ameliorating the problem of the ununiform brightness of the display frame of the display module, and improving the effect of displaying.

In some embodiments of the present application, the to-be-compensated light area includes at least one of the other light areas than the reference light area.

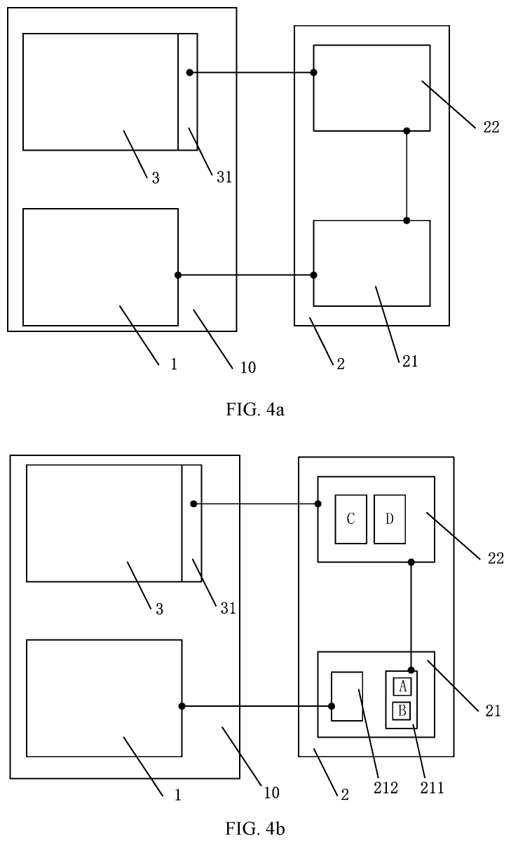

An embodiment of the present application provides a brightness regulating system, referring to FIG. 4a, the brightness regulating system comprises: a controller 2 and a display module 10, the display module 10 comprises a backlight module 1 and a display panel 3, and the backlight module 1 and the display panel 3 are electrically connected to the controller 2.

The controller 2 comprises an area dividing and light regulating unit 21 and a controlling unit 22. The area dividing and light regulating unit 21 is electrically connected to the controlling unit 22 and the backlight module 1.

The area dividing and light regulating unit 21 is configured for dividing the backlight module 1 into a plurality of light areas; according to brightnesses of the light areas, determining a reference light area; and according to a brightness of the reference light area, determining a compensation parameter of a to-be-compensated light area.

The controlling unit 22 is configured for acquiring the compensation parameter, and converting the compensation parameter into compensated-grayscale data of the display panel; and according to the compensated-grayscale data, controlling a display frame corresponding to the to-be-compensated light area to display a brightness that has been updated.

In an exemplary embodiment, the controller 2 may be a time schedule controller (TCON), the area dividing and light regulating unit 21 may be an area dividing and light regulating controller (LDC, Local Dimming Controller), and the controlling unit 22 may be an MCU (Microcontroller Unit).

In an embodiment of the present application, the backlight module may be a backlight module of the Mini LED type, and may also be a backlight module of the Micro LED type, which is particularly determined according to actual situations, and is not limited herein.

In an exemplary embodiment, the system further comprises a PC motherboard or a video collecting card (Graphics Cards). The PC motherboard or video collecting card may be connected to the controller 2 by an EDP interface, to transmit a video-stream signal to the controller 2. The modules in the controller 2 perform logical operation to the video-stream signal, and transmit the obtained signal to the display panel 3 via an SPI interface, thereby regulating the overall brightness of the display module by controlling the transmittances of the pixels in the display panel.

In an exemplary embodiment, the controller 2 is electrically connected to the backlight module 1 by an LED driver.

It should be noted that the EDP interface is a fully digitalized interface based on the Display Port architecture and protocol, may transmit a high-resolution signal by using a simple connector and a few leads, and may realize simultaneous transmission of multiple data. The SPI (Serial Peripheral Interface) is a synchronous serial peripheral interface, and may enable the MCU to communicate with various peripheral devices in a serial manner to exchange information.

In the brightness regulating system according to the embodiments of the present application, the light area that has the maximum brightness in the same one frame of the display frame is used as the reference light area; by using the brightness of the reference light area as the reference, the compensation parameter is determined according to the brightness of the reference light area and the brightness of the to-be-compensated light area; subsequently, the compensation parameter of the to-be-compensated light area is converted into the compensated-grayscale data of the display panel; and according to the compensated-grayscale data, the transmittance of the display panel is adjusted, to realize the purpose of compensating the backlight brightnesses of the different light areas by using the compensated-grayscale data of the display panel, thereby ameliorating the problem of the ununiform brightness of the display frame of the display module, and improving the effect of displaying.

In some embodiments of the present application, referring to FIG. 4b, the area dividing and light regulating unit 21 comprises an area dividing subunit 212 and a light regulating subunit 211.

The area dividing subunit 212 is configured for dividing the backlight module 1 into a plurality of light areas.

The light regulating subunit 211 is configured for, according to brightnesses of the light areas, determining a reference light area; and according to a brightness of the reference light area, determining a compensation parameter of a to-be-compensated light area.

As an example, the area dividing and light regulating unit 21 may be an area dividing and light regulating controller (LDC. Local Dimming Controller), and the area dividing and light regulating controller may comprise an area dividing subunit and a light regulating subunit 211.

Particularly, the area dividing subunit 212 controls each of the light areas separately to be lightened or extinguished, to reach the object of area delimitation. The light regulating subunit 211 controls to increase or reduce the brightness of each of the light areas, and the light regulating subunit 211 may, according to the brightnesses of the light areas in the same one frame of the display frame, determine the light area that has the maximum brightness to be the reference light area, and subsequently, according to the brightness of the reference light area and the brightness of the to-be-compensated light area, determine the compensation parameter.

In an exemplary embodiment, the light regulating subunit 211 comprises a first data acquiring module A and a compensation calculating module B. The first data acquiring module A is configured for, in one frame of the display frame, acquiring the brightnesses of the light areas; acquiring the brightness of the reference light area; and acquiring the brightness of the to-be-compensated light area. The compensation calculating module B is configured for selecting a light area having a maximum brightness to be the reference light area; and according to the brightness of the reference light area and the brightness of the to-be-compensated light area in the same one frame of the display frame, determining a compensation parameter of a to-be-compensated light area, wherein the compensation parameter refers to a ratio of the brightness of the reference light area to the brightness of the to-be-compensated light area in the same one frame of the display frame.

Each to-be-compensated light area corresponds to one compensation parameter. For example, in the same one frame of the frame, a light area a is the reference light area and has a brightness of Yref, and a light area b is the to-be-compensated light area and has a brightness of Yb. Accordingly, the compensation parameter of the light area b is Yref/Yb.

In some embodiments of the present application, referring to FIG. 4b, the controlling unit 22 comprises a second data acquiring module C and a compensation correcting module D.

The second data acquiring module C is configured for acquiring the compensation parameter of the to-be-compensated light area.

The compensation correcting module D is configured for converting the compensation parameter into compensated-grayscale data of the display panel; and according to the compensated-grayscale data, controlling to update a transmittance of a display panel corresponding to the to-be-compensated light area, wherein the brightness that has been updated of the display frame corresponding to the to-be-compensated light area is equal to a product obtained by multiplying the brightness of the to-be-compensated light area by a transmittance that has been updated.

In an exemplary embodiment, the compensated-grayscale data may include the pixel-grayscale values and the pixel voltages of the pixels of a local area of the display panel corresponding to the to-be-compensated light area.

As an example, the compensation correcting module D may be a Gamma corrector (Gamma Correction).

Particularly, the Gamma corrector, according to the compensation parameter acquired by the second data acquiring module, calculates the corresponding compensated-grayscale value, and sends the compensated-grayscale value to a driving chip 31 of the display panel (for example, a source driving chip, which is also referred to as Source Driver), the driving chip 31 is electrically connected to the data-signal lines in the display panel 3 that are arranged in an array, the driving chip 31 converts the compensated-grayscale value into the pixel-voltage value, and transmits the pixel-voltage value to the pixel units via the data-signal lines, and the pixel units adjust the transmittances thereof according to the pixel-voltage value, thereby regulating the brightness of the display panel 3 corresponding to the to-be-compensated light area.

In some embodiments of the present application, the brightnesses of the light areas are determined according to the maximum grayscales of the display frames corresponding to the light areas.

In the embodiments of the present application, according to the maximum grayscales of the display frames corresponding to the light areas, the brightnesses of the light areas are determined, which, as compared with the case in which the brightnesses of all of the light areas are controlled to be equal, may significantly reduce the power consumption of the backlight module, and reduce the cost.

In some embodiments of the present application, the to-be-compensated light area includes at least one of the other light areas than the reference light area.

An embodiment of the present application further provides a display device, wherein the display device comprises the brightness regulating system stated above.

In an exemplary embodiment, the display device comprises a display module 10 and a controller 2, and the display module 10 comprises a backlight module 1 and a display panel 3.

The controller 2 may comprise a time schedule controller (TCON).

In an exemplary embodiment, the display device may be a display device of the technique of SDR (Standard Dynamic Range), and may also be a display device of the technique of HDR (High-Dynamic Range).

In an exemplary embodiment, the display panel in the display device is an LCD display panel (Liquid Crystal Display), and the liquid-crystal display panel may be liquid-crystal display panels such as the TN (Twisted Nematic) type, the VA (Vertical Alignment) type, the IPS (In-Plane Switching) type and the ADS (Advanced Super Dimension Switch) type.

In the display device according to the embodiments of the present application, the light area that has the maximum brightness in the same one frame of the display frame is used as the reference light area; by using the brightness of the reference light area as the reference, the compensation parameter is determined according to the brightness of the reference light area and the brightness of the to-be-compensated light area; subsequently, the compensation parameter of the to-be-compensated light area is converted into the compensated-grayscale data of the display panel; and according to the compensated-grayscale data, the transmittance of the display panel is adjusted, to realize the purpose of compensating the backlight brightnesses of the different light areas by using the compensated-grayscale data of the display panel, thereby ameliorating the problem of the ununiform brightness of the display frame of the display module, and improving the effect of displaying.

All of the other indispensable components of the display device are used, as understood by a person skilled in the art, which is not discussed herein further, and should not be used as a limitation on the present disclosure. The process of the brightness regulation by the display device may refer to the above particular description on the regulating system or refer to the embodiments of the brightness regulating method, and the repeated parts are not discussed further.

The above are merely particular embodiments of the present application, and the protection scope of the present application is not limited thereto. All of the variations or substitutions that a person skilled in the art may easily envisage within the technical scope disclosed by the present application should fall within the protection scope of the present application. Therefore, the protection scope of the present application should be subject to the protection scope of the claims.

1. A brightness regulating method, wherein the brightness regulating method is applied to a display module, the display module comprises a backlight module and a display panel, the display panel is located on a light exiting side of the backlight module, and the brightness regulating method comprises:
dividing the backlight module into a plurality of light areas;
according to brightnesses of the light areas, determining a reference light area;
according to a brightness of the reference light area, determining a compensation parameter of a to-be-compensated light area;
converting the compensation parameter into compensated-grayscale data of the display panel; and
according to the compensated-grayscale data, controlling a display frame corresponding to the to-be-compensated light area to display a brightness that has been updated.

2. The brightness regulating method according to claim 1, wherein the step of, according to the brightnesses of the light areas, determining the reference light area comprises:
in one frame of the display frame, determining the brightnesses of the light areas; and
selecting a light area having a maximum brightness to be the reference light area.

3. The brightness regulating method according to claim 1, wherein the step of, according to the brightness of the reference light area, determining the compensation parameter of the to-be-compensated light area comprises:
in one frame of the display frame, determining the brightness of the reference light area;
determining a brightness of the to-be-compensated light area; and
according to the brightness of the reference light area and the brightness of the to-be-compensated light area in a same one frame of the display frame, determining the compensation parameter of the to-be-compensated light area.

4. The brightness regulating method according to claim 3, wherein the step of, according to the brightness of the reference light area and the brightness of the to-be-compensated light area in the same one frame of the display frame, determining the compensation parameter of the to-be-compensated light area comprises:
regarding a ratio of the brightness of the reference light area to the brightness of the to-be-compensated light area in the same one frame of the display frame as the compensation parameter of the to-be-compensated light area.

5. The brightness regulating method according to claim 1, wherein the step of, according to the compensated-grayscale data, controlling the display frame corresponding to the to-be-compensated light area to display the brightness that has been updated comprises:
according to the compensated-grayscale data, updating a transmittance of a display panel corresponding to the to-be-compensated light area, wherein the brightness that has been updated of the display frame corresponding to the to-be-compensated light area is equal to a product obtained by multiplying the brightness of the to-be-compensated light area by a transmittance that has been updated.

6. The brightness regulating method according to claim 2, wherein the step of, in the one frame of the display frame, determining the brightnesses of the light areas comprises:
in the one frame of the display frame, determining maximum grayscales of display frames corresponding to the light areas; and
according to the maximum grayscales of the display frames corresponding to the light areas, determining the brightnesses of the light areas.

7. The brightness regulating method according to claim 1, wherein the to-be-compensated light area includes at least one of the other light areas than the reference light area.

8. A brightness regulating system, wherein the brightness regulating system comprises: a controller and a display module, the display module comprises a backlight module and a display panel, and the backlight module and the display panel are electrically connected to the controller;
the controller comprises an area dividing and light regulating unit and a controlling unit;
the area dividing and light regulating unit is electrically connected to the controlling unit and the backlight module;
the area dividing and light regulating unit is configured for dividing the backlight module into a plurality of light areas; according to brightnesses of the light areas, determining a reference light area; and according to a brightness of the reference light area, determining a compensation parameter of a to-be-compensated light area; and
the controlling unit is configured for acquiring the compensation parameter, and converting the compensation parameter into compensated-grayscale data of the display panel; and according to the compensated-grayscale data, controlling a display frame corresponding to the to-be-compensated light area to display a brightness that has been updated.

9. The brightness regulating system according to claim 8, wherein the area dividing and light regulating unit comprises an area dividing subunit and a light regulating subunit;
the area dividing subunit is configured for dividing the backlight module into the plurality of light areas; and
the light regulating subunit is configured for, according to brightnesses of the light areas, determining the reference light area; and according to a brightness of the reference light area, determining the compensation parameter of the to-be-compensated light area.

10. The brightness regulating system according to claim 9, wherein the light regulating subunit comprises a first data acquiring module and a compensation calculating module;
the first data acquiring module is configured for, in one frame of the display frame, acquiring the brightnesses of the light areas; acquiring the brightness of the reference light area; and acquiring the brightness of the to-be-compensated light area; and
the compensation calculating module is configured for selecting a light area having a maximum brightness to be the reference light area; and according to the brightness of the reference light area and the brightness of the to-be-compensated light area in a same one frame of the display frame, determining the compensation parameter of the to-be-compensated light area, wherein the compensation parameter refers to a ratio of the brightness of the reference light area to the brightness of the to-be-compensated light area in the same one frame of the display frame.

11. The brightness regulating system according to claim 8, wherein the controlling unit comprises a second data acquiring module and a compensation correcting module;
the second data acquiring module is configured for acquiring the compensation parameter of the to-be-compensated light area; and
the compensation correcting module is configured for converting the compensation parameter into compensated-grayscale data of the display panel; and according to the compensated-grayscale data, controlling to update a transmittance of a display panel corresponding to the to-be-compensated light area, wherein the brightness that has been updated of the display frame corresponding to the to-be-compensated light area is equal to a product obtained by multiplying the brightness of the to-be-compensated light area by a transmittance that has been updated.

12. The brightness regulating system according to claim 10, wherein the brightnesses of the light areas are determined according to the maximum grayscales of the display frames corresponding to the light areas.

13. The brightness regulating system according to claim 8, wherein the to-be-compensated light area includes at least one of the other light areas than the reference light area.

14. A display device, wherein the display device comprises the brightness regulating system according to claim 8.

15. The device according to claim 14, wherein the area dividing and light regulating unit comprises an area dividing subunit and a light regulating subunit;
the area dividing subunit is configured for dividing the backlight module into the plurality of light areas; and
the light regulating subunit is configured for, according to brightnesses of the light areas, determining the reference light area; and according to a brightness of the reference light area, determining the compensation parameter of the to-be-compensated light area.

16. The device according to claim 15, wherein the light regulating subunit comprises a first data acquiring module and a compensation calculating module;
the first data acquiring module is configured for, in one frame of the display frame, acquiring the brightnesses of the light areas; acquiring the brightness of the reference light area; and acquiring the brightness of the to-be-compensated light area; and
the compensation calculating module is configured for selecting a light area having a maximum brightness to be the reference light area; and according to the brightness of the reference light area and the brightness of the to-be-compensated light area in a same one frame of the display frame, determining the compensation parameter of the to-be-compensated light area, wherein the compensation parameter refers to a ratio of the brightness of the reference light area to the brightness of the to-be-compensated light area in the same one frame of the display frame.

17. The device according to claim 14, wherein the controlling unit comprises a second data acquiring module and a compensation correcting module;
the second data acquiring module is configured for acquiring the compensation parameter of the to-be-compensated light area; and
the compensation correcting module is configured for converting the compensation parameter into compensated-grayscale data of the display panel; and according to the compensated-grayscale data, controlling to update a transmittance of a display panel corresponding to the to-be-compensated light area, wherein the brightness that has been updated of the display frame corresponding to the to-be-compensated light area is equal to a product obtained by multiplying the brightness of the to-be-compensated light area by a transmittance that has been updated.

18. The device according to claim 17, wherein the brightnesses of the light areas are determined according to the maximum grayscales of the display frames corresponding to the light areas.

19. The device according to claim 14, wherein the to-be-compensated light area includes at least one of the other light areas than the reference light area.
